(19) United States
(12) Patent Application Publication
(10) Pub. No.: US 2011/0162064 A1
(43) Pub. Date: Jun. 30, 2011

(54) System and Method for Providing Convergent Physical/Logical Location Aware Access Control

(75) Inventors: William Shane Powell, Gibsonton, FL (US); Averett Wade Nelson Thompson, St. Petersburg, FL (US); Samuel Jeffrey Biller, Tampa, FL (US)

(73) Assignee: RAYTHEON COMPANY, Waltham, MA (US)

(21) Appl. No.: 12/650,866

(22) Filed: Dec. 31, 2009

(51) Int. Cl. G06F 21/00

(52) U.S. Cl. 726/17

(57) ABSTRACT

A method for enforcing physical access control and logical access control may include: (i) controlling access of a person to a physical location based on a physical access credential associated with the person provided to a physical access control system; (ii) controlling access of the person to an information system and an enterprise service based on a logical access credential associated with the person provided to a logical access control system; (iii) receiving information from the physical access control system regarding the physical access credential; (iv) receiving information from the logical access control system regarding the logical access credential; (v) determining an approximate location of the person based on the physical access credential and the logical access credential; and (vi) blocking unauthorized access between the physical access control system and the logical access control system by a first firewall.

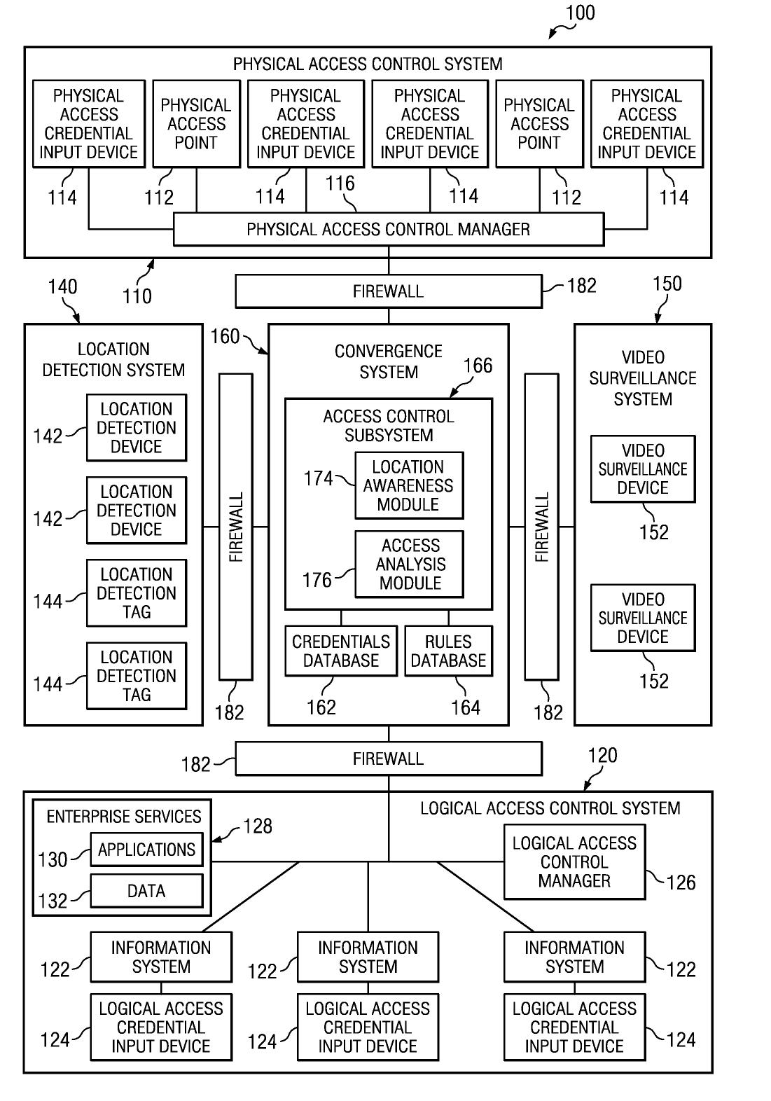

### RELATED APPLICATION

This application is related to co-pending patent application entitled “System and Method for Providing Convergent Physical/Logical Location Aware Access Control,” application Ser. No. ______ (064750.0574), filed on the same date as the present application.

### TECHNICAL FIELD

This disclosure relates in general to physical and logical system security and more particularly to a system and method for providing convergent physical/logical location aware access control.

### BACKGROUND

To guard against unauthorized access to both facilities and data, enterprises often use some combination of physical access control security systems and logical access control systems. As its name indicates, a physical access control system is a system that controls physical access to a physical location (e.g., a building, a particular area or zone of a building, etc.) based on one or more credentials supplied by a person (e.g., an access card, personal identification number, biometric, etc.). Similarly, a logical access control system is a system that controls access to computers, workstations, and other electronic devices based on one or more credentials supplied by a person (e.g., a password, personal identification number, access card, biometric, etc.).

By combining physical access control with logical access control, access control may be strengthened and ease of user experience may also be increased as it may eliminate the need to provide multiple credentials to access each of the physical and logical systems. However, consolidation of physical access control systems and logical access control systems may introduce security risks (e.g., a physical access control system may be vulnerable to attack vectors introduced by a logical access control system, and vice versa) that may not otherwise be present in isolated systems.

In addition, existing access control systems are limited in their ability to track locations of various assets and equipment and the locations of credentialed and non-credentialed persons relative to such assets and equipment. Due to such limitations, non-credentialed persons may from time to time undesirably obtain access to physical areas of logical systems. For example, a non-credentialed person may “tailgate” a credentialed person through an access controlled point, and thus may be undesirably exposed to data and information to which the non-credentialed person is not authorized to access.

### SUMMARY OF THE DISCLOSURE

According to one embodiment, a method for enforcing physical access control and logical access control may include controlling access of a person to a physical location based on a physical access credential associated with the person provided to a physical access control system. The method may further include controlling access of the person to an information system and an enterprise service based on a logical access credential associated with the person provided to a logical access control system. The method may additionally include receiving information from the physical access control system regarding the physical access credential. The method may also include receiving information from the logical access control system regarding the logical access credential. Moreover, the method may include determining an approximate location of the person based on the physical access credential and the logical access credential. Additionally, the method may include blocking unauthorized access between the physical access control system and the logical access control system by a first firewall.

Technical advantages of certain embodiments may include the effective convergence of physical access control, logical access control, with heightened location awareness as compared to traditional approaches.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

THE FIGURE illustrates a block diagram illustrating selected components of an example physical/logical location aware access control system, in accordance with certain embodiments of the present disclosure.

### DETAILED DESCRIPTION OF THE DISCLOSURE

Embodiments of the present disclosure and its advantages are best understood by referring to THE FIGURE, like numerals being used for like and corresponding parts of the various drawings.

THE FIGURE illustrates a block diagram illustrating selected components of an example physical/logical location aware access control system 100, in accordance with certain embodiments of the present disclosure. As shown in THE FIGURE, system 100 may include a physical access control system 110, a logical access control system 120, a location detection system 140, a video surveillance system 150, and a convergence system 160 communicatively coupled to each of the physical access control system 110, the logical access control system 120, the location detection system 140, and the video surveillance system 150 via a firewall 182.

As shown in THE FIGURE, physical access control system 110 may include one or more physical access points 112, one or more physical access credential input devices 114 associated with physical access points 112, and a physical access control manager 116 communicatively coupled to the one or more physical access points 112 and the one or more physical access credential input devices 114. Physical access points 112 may include any system, apparatus or device that presents a physical barrier to ingress to or egress from a structure or a portion thereof (e.g., a door, gate, or cage at a building entrance or at an entrance of a particular room or wing of a building). One or more physical access credential input devices 114 may be physically located proximate to and may be associated with each physical access point 112. For example, a physical access credential input device 114 may include a smart card reader, a radio-frequency identification (RFID) card reader, a proximity card reader, a personal identification number (PIN) input device, passcode input device, biometric input device (e.g., fingerprint scanner, retinal scanner, voice-recognition device), or other suitable input device. By providing a proper physical access credential for the physical access credential input device 114, a person may be granted access through the associated physical access point 112 (e.g., a door may be unlocked in response to a proper credential being provided). In certain embodiments, a physical access point 112 may be associated with two or more physical access credential input devices 114. For example, a physical access point 112 may be associated with an ingress physical access credential input device 114 that may permit and/or log granted accesses to a secured building or portion of a building, and also associated with an egress physical access credential input device 114 that may log the egress of credentialed persons from the secured building or secured portion of a building.

Physical access control manager 116 may include any system, device, or apparatus configured to control access to physical access points 112 based on input received by physical access credential input devices 114. For example, in some embodiments physical access control manager 116 may be a computer or other information system communicatively coupled to physical access credential input devices 114 and configured to receive physical access credential information from physical access credential input devices 114 and based on such received information, control access through physical access points 112 (e.g., locking or unlocking electronic locks associated with physical access points 112).

As shown in THE FIGURE, logical access control system 120 may include one or more information systems 122, one or more logical access credential input devices 124 communicatively coupled to an associated information system 122, a logical access control manager 126 communicatively coupled to the one or more information systems 122, and enterprise services 128 communicatively coupled to the one or more information systems 122 and the logical access control manager 126. Information systems 122 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information system may be a personal computer, a PDA, a consumer electronic device, a network storage device, or any other suitable device and may vary in size, shape, performance, functionality, and price.

Each information system 122 may be communicatively coupled to and/or associated with a logical access credential input device 124. For example, a logical access credential input device 124 may include a smart card reader, a radio-frequency identification (RFID) card reader, a proximity card reader, a personal identification number (PIN) input device, passcode input device, biometric input device (e.g., fingerprint scanner, retinal scanner, voice-recognition device), or other suitable input device. In some embodiments, one or more of logical access credential input devices 124 may be identical or similar to one or more of physical access credential input devices 114, thus facilitating ease of use for credentialed persons, by eliminating the necessity of remembering and/or carrying multiple credentials. By providing a proper logical access credential for the logical access credential input device 124, a person may be granted access to the associated information system 122, as well as access to all or a portion of enterprise services 128 via the information system 122. In some embodiments, the logical access credential may be stored on or carried on the same form factor as the physical access credential (e.g., a smart card, passive RFID tag, active RFID tag, etc.). In the same or alternative embodiments, the logical access credential may be substantially identical the physical access credential.

Logical access control manager 126 may include any system, device, or apparatus configured to control access to an information system 122 and/or access to enterprise services 128 via such information handling system 122 based on input received by a logical access credential input device 124 communicatively coupled to and/or associated with such information handling system 122. For example, in some embodiments logical access control manager 126 may be configured to receive credential input information from logical access credential input devices 124 via their associated information systems 122, and based on such received information, control access to information systems 122 (e.g., permit log on and use to an information system 122) and/or control access to enterprise services 128 via an information system 122 (e.g., permit access to certain applications 130 and/or data based on such received credential information).

As shown in THE FIGURE, enterprise services 128 may include applications 130 and/or data 132, access to which may be controlled by logical access control manager 126 based on credential information input received at logical access credential input devices 124, as described in greater detail above.

As depicted in THE FIGURE, location detection system 140 may include one or more location detection devices 142 and one or more location detection tags 144. A location detection device 142 may include any system, device, or apparatus configured to, alone or in combination with other location detection devices, determine a location of a location detection tag 144. In some embodiments, location detection device 142 may detect the location of a location detection tag 144 based on the proximity of the location detection tag 144 to a location detection device 142. For example, signal originating from a location detection tag 144 may be detected to have a certain signal strength when located a particular distance from a location detection device 142, may have weaker signal strength if located further from the same location detection device 142, and have a stronger signal strength if located closer to the same location detection device 142. As another example, to detect the distance of a location detection tag 144 from a location detection device 142, the location detection device 142 may broadcast a signal, and the distance may be determined by the time required for the location detection device 142 to receive a response signal communicated from the location detection tag 144. As a further example, to detect the distance of a location detection tag 144 from a location detection device 142, the location detection tag 144 may broadcast a signal, and the distance may be determined by the time required for the location detection tag 144 to receive a response signal communicated from the location detection tag 142. In these and other embodiments, a plurality of location detection devices 142 may be employed to triangulate an approximate location of a location detection tag 144 based on communicated and/or received signals. Specific examples of a location detection device 142 may include a radio frequency identification (RFID) reader, a wireless access point, a global positioning system (GPS) satellite, a sonic receiver, a proximity sensor, or any other suitable device.

A location detection tag 144 may include system, device or apparatus that may transmit, communicate, or otherwise indicate its presence to a location detection device 142 within a certain proximity to the location detection tag 144. In some embodiments, a location detection tag 144 may include a passive tag, wherein the passive tag transmits a signal to indicate its presence in response to a received signal, but may not autonomously transmit a presence signal in the absence of a received signal. In other embodiments, a location detection tag 144 may include an active tag, wherein the active tag may transmit a signal autonomously in the absence of a received signal. Specific examples of a location detection tag may include an RFID tag, a wireless transmitter and/or receiver, a GPS positioning device, a sonic tag, a proximity card, or any other suitable device.

In operation of location detection system 140, location detection tags 144 may be carried by persons with access to one or more components of system 100 and/or affixed to assets and/or equipment (e.g., to information systems 122 and other valuable assets and equipment). In instances in which location detection tags 144 are carried by persons, location detection tags 144 may be of a similar or identical form factor to that used to store physical access credentials and/or logical access credentials (e.g., smart card, passive RFID tag, active RFID tag), thus facilitating ease of use by eliminating the necessity of carrying multiple credentials. By detecting the locations of individual location detection tags 144, location detection devices 142 may be able to detect the locations of assets and persons associated with the individual location detection tags 144.

As depicted in THE FIGURE, video surveillance system 150 may include one or more video surveillance devices 152. Each video surveillance device 152 may be any system, device, or apparatus suitable for electronic motion picture acquisition, for example, a video camera. In operation, motion pictures acquired by video surveillance devices 152 may be communicated to convergence system 160 for analysis, as described in greater detail below.

As shown in THE FIGURE, convergence system 160 may include credentials database 162, rules database 164, and access control subsystem 166. Credentials database 162 may be any database, table, listing, file, or collection of data storing various credentials for authenticating physical and logical access of persons to components of system 100. For example, for each person with access to components of system 100, credentials database 162 may include PINs, passcodes, smart card identifier numbers, RFID tag identifier numbers, biometric data, and/or other information that may be used to authenticate such person's access to physical access points 112, information systems 122, or enterprise services 128. In certain embodiments, credentials database 162 may comprise a credentials repository or silo for each credentialed person, such that a person's provision of one type of credential (e.g., a smart card) may automatically provision other credentials (e.g., passwords to information systems 122 and/or enterprise services 128) associated with such person to allow such person to have a single sign-on to information systems 122, enterprise services 128, and/or other components of system 100.

Rules database 164 may be any database, table, listing, file, or collection of data storing various rules regarding actions to be taken by convergence system 160 based on a location of a person, a location of an item of equipment, access permissions of such person, and/or other factors. For example, a rule in rules database 164 may provide that if a person is in a room within a building to which such person does not have access, convergence system 160 is to provide an alarm and/or lock information systems 122 in such room. Other examples of rules that may be included in rules database 164 are provided below.

As shown in THE FIGURE, access control subsystem 166 may include location awareness module 174 and access analysis module 176. Location awareness module 174 may include any system, device or apparatus configured to analyze information received from physical access control system 110, logical access control system 120, location detection system 140, and/or video surveillance system 150 to determine a location of a person or equipment. For example, by analyzing data communicated to convergence system 160 by physical access control system 110, location awareness module 174 may determine whether or not a particular credentialed person is present in a building or portion of a building. As an additional example, by analyzing data communicated to convergence system 160 by logical access control system 120, location awareness module 174 may determine that a credentialed person is located near a particular information system 122 (e.g., if the location of the particular information system 122 is known and a person has supplied credentials to that information system 122, location awareness module 174 may determine that the person is approximately located at the same location as the information system 122).

As a further example, by analyzing data communicated to convergence system 160 by location detection system 140, location awareness module 174 may be able to determine the locations of persons carrying location detection tags 144 and/or the locations of equipment (e.g., information systems 122) having location detection tags 144 based on proximity of such persons or equipment to location detection devices 142.

As yet another example, by analyzing data communicated to convergence system 160 by video surveillance system 150, location awareness module 174 may be able to determine biometric characteristics of persons recorded by video surveillance system 150, compare such biometric characteristics to those present in credentials database 160, and determine locations of persons based on the physical locations of video surveillances devices 152 of video surveillance system 150 and/or such biometric characteristics.

Access analysis module 176 may be any system, device, or apparatus configured to analyze locations of persons and/or equipment determined by location awareness module, analyze rules database 164, and/or analyze credentials database 162, and to apply a rule if such analyses indicate such rule in rules database 164 should be applied. Non-limiting, non-exhaustive examples of applications of rules in rules database 164 are provided below.

### Example 1

Based on Analysis of Information received from one or more of physical access control system 110, logical access control system 120, location detection system 140, and video surveillance system 150, access analysis module 176 may determine that a person logged into a particular information system 122 and subsequently, without locking or logging out of such information system 122, moved a particular distance away from such information system 122. The movement of such person may invoke a rule in rules database 164, and accordingly, access analysis module 176 may apply such rule (e.g., access analysis module 176 may automatically lock or log the person out of the particular information system 122 if the person moves more than a specified distance from the particular information system 122).

### Example 2

Based on analysis of information received from one or more of physical access control system 110, logical access control system 120, location detection system 140, and video surveillance system 150, access analysis module 176 may determine that a particular person is located in an area of a building for which the particular person is not authorized to access. The presence of a person in an unauthorized area may invoke a rule in rules database 164 that may be applied by access analysis module 176 (e.g., access analysis module 176 may communicate an alert or alarm to security personnel and/or lock all information systems 122 in such area to prevent the unauthorized person from gaining access to such information systems 122).

### Example 3

Based on analysis of information received from one or more of physical access control system 110, logical access control system 120, location detection system 140, and video surveillance system 150, access analysis module 176 may determine that a particular item of equipment has been transported from an area of a building for which it is authorized. The transport of the item of equipment may invoke a rule in rules database 164 that may be applied by access analysis module 176 (e.g., access analysis module 176 may communicate an alert or alarm to security personnel and/or lock physical access points 112 to prevent further unauthorized transport of the item of equipment).

As depicted in THE FIGURE, firewalls 182 may be interfaced between convergence system 160 and one or more of physical access control system 110, logical access control system 120, location detection system 140, and video surveillance system 150. A firewall 182 may be any system, device, or apparatus configured to block unauthorized access while permitting authorized communications. A firewall 182 may comprise a device or set of devices (e.g., one or more information systems) configured to permit, deny, encrypt, decrypt, or proxy all (in and out) computer traffic between different security domains based upon a set of rules and other criteria. In system 100, each of physical access control system 110, logical access control system 120, location detection system 140, and video surveillance system 150 may comprise a security domain to which a firewall 182 may block unauthorized access while permitting authorized communications. Accordingly, physical access control system 110, logical access control system 120, location detection system 140, and/or video surveillance system 150 may be effectively merged, while preventing each from being used to gain unauthorized access to the others.

A component system 100 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible computer readable storage media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Although the embodiments in the disclosure have been described in detail, numerous changes, substitutions, variations, alterations, and modifications may be ascertained by those skilled in the art. It is intended that the present disclosure encompass all such changes, substitutions, variations, alterations and modifications as falling within the spirit and scope of the appended claims.

What is claimed is:

1. A system for enforcing physical access control and logical access control, comprising:
a physical access control system configured to control access of a person to a physical location based on a physical access credential associated with the person;
a logical access control system configured to control access of the person to an information system and an enterprise service based on a logical access credential associated with the person;
a convergence system communicatively coupled to the physical access control system and the logical access control system and configured to:
receive information from the physical access control system regarding the physical access credential;
receive information from the logical access control system regarding the logical access credential; and
based on analysis of information regarding the physical access credential and information regarding the logical access credential, determine an approximate location of the person; and
a first firewall configured to block unauthorized access between the physical access control system and the logical access control system.

2. A system according to claim 1, the first firewall interfaced between the physical access control system and the convergence system.

3. A system according to claim 2, comprising a second firewall interfaced between the logical access control system and the convergence system, the second firewall configured to block unauthorized access between the physical access control system and the logical access control system.

4. A system according to claim 1, the first firewall interfaced between the logical access control system and the convergence system.

5. A system according to claim 1, wherein the physical access credential and logical access credential are substantially identical.

6. A system according to claim 1, wherein the physical access credential and logical access credential are stored on a form factor.

7. A system according to claim 1, wherein the form factor comprises one of a smart card, an active radio-frequency identification (RFID) tag, and a passive RFID tag.

8. A system according to claim 1, wherein the convergence system is further configured to:
based on the determined approximate location of the person, determine if a rule is to be applied; and
enforce the rule in response to a determination is to be applied.

9. A method for enforcing physical access control and logical access control, comprising:
controlling access of a person to a physical location based on a physical access credential associated with the person provided to a physical access control system;
controlling access of the person to an information system and an enterprise service based on a logical access credential associated with the person provided to a logical access control system;
receiving information from the physical access control system regarding the physical access credential;
receiving information from the logical access control system regarding the logical access credential;
determining an approximate location of the person based on the physical access credential and the logical access credential; and
blocking unauthorized access between the physical access control system and the logical access control system by a first firewall.

10. A method according to claim 9, further comprising interfacing the first firewall between the physical access control system and the convergence system.

11. A method according to claim 10, further comprising interfacing a second firewall between the logical access control system and the convergence system, the second firewall configured to block unauthorized access between the physical access control system and the logical access control system.

12. A method according to claim 9, further comprising interfacing the first firewall between the logical access control system and the convergence system.

13. A method according to claim 9, wherein the physical access credential and logical access credential are substantially identical.

14. A method according to claim 9, wherein the physical access credential and logical access credential are stored on a form factor.

15. A method according to claim 9, wherein the form factor comprises one of a smart card, an active radio-frequency identification (RFID) tag, and a passive RFID tag.

16. A method according to claim 9, further comprising:
determining if a rule is to be applied based on the determined approximate location of the person; and
enforcing the rule in response to a determination is to be applied.

17. Logic for enforcing physical access control and logical access control, the logic embodied in a computer-readable storage medium and when executed by a computer configured to:
control access of a person to a physical location based on a physical access credential associated with the person provided to a physical access control system;
control access of the person to an information system and an enterprise service based on a logical access credential associated with the person provided to a logical access control system;
receive information from the physical access control system regarding the physical access credential;
receive information from the logical access control system regarding the logical access credential;
determine an approximate location of the person based on the physical access credential and the logical access credential; and
block unauthorized access between the physical access control system and the logical access control system by a first firewall.

18. Logic according to claim 17, wherein the physical access credential and logical access credential are stored on a form factor.

19. Logic according to claim 17, wherein the form factor comprises one of a smart card, an active radio-frequency identification (RFID) tag, and a passive RFID tag.

20. Logic according to claim 17, the logic further configured to:
determine if a rule is to be applied based on the determined approximate location of the person; and
enforce the rule in response to a determination is to be applied.
